(19) United States
(12) Patent Application Publication
(10) Pub. No.: US 2012/0267970 A1
(43) Pub. Date: Oct. 25, 2012

(54) Coolant Flow Channel Arrangement for a Fluid Cooled Electric Motor

(75) Inventors: Ethan FILIP, Christiansburg, VA (US); Ken DILLON, Blacksburg, VA (US); Stephen Mark FIELDS, Newport, VA (US)

(73) Assignee: Kollmorgen Corporation, Radford, VA (US)

(21) Appl. No.: 13/452,227

(22) Filed: Apr. 20, 2012

Related U.S. Application Data
(60) Provisional application No. 61/477,989, filed on Apr. 21, 2011.

(51) Int. Cl. H02K 9/19

(52) U.S. Cl. 310/54

(57) ABSTRACT

An improved fluid cooling arrangement for an electric machine, such as an electric motor, a generator, or a motor/generator assembly, is provided. In its most general sense, the fluid-cooled electric machine includes a rotor disposed on a motor shaft, a stator surrounding the rotor, and a motor housing surrounding the stator, with the stator formed of a laminated stack of stator plates that is plated at its outer surface.

### CROSS-REFERENCE TO RELATED APPLICATIONS

This is a non-provisional application claiming priority to U.S. provisional application Ser. No. 61/477,989, filed Apr. 21, 2011, the entire disclosure of which is expressly incorporated by reference herein.

### BACKGROUND OF THE INVENTION

1. Field of the Invention

The present invention concerns an improved fluid cooling arrangement for an electric motor, generator, or motor/generator assembly. Such assemblies have numerous applications in a variety of fields, and are particularly useful in hybrid vehicle market applications. Use of the invention could occur, for example, in trucks, military vehicles, off-road vehicles, or other automotive vehicles.

2. Description of Related Art

Use of liquid cooling to remove heat from electric motors has been known. For example, U.S. Pat. No. 5,331,238 to Johnsen discloses an electric motor with a stator having three axial cooling channels between an outer circumference of the stator and an inner diameter of the electric motor housing. In the Johnsen electric motor, the rotor is made up from a series of stacked rotor plates, and the three cooling channels are defined by projections on the outer periphery of the stator plates which locate the stator within the housing. Johnsen further discloses that by offsetting the locating projections from one another along the length of the stator, the support for the stator within the motor housing may be distributed to avoid undesired heat-related distortion of the motor housing, while also providing a twist to the axial cooling flow channels.

The prior art approaches to electric motor cooling have a number of disadvantages, including lack of adequate heat transfer to the cooling medium (typically an oil coolant) due to relatively short exposure of the cooling oil to the stator along relatively short one-pass axial flow paths, and uneven cooling of the stator where a significant portion of the circumference of the stator may not be exposed to any significant amount of cooling oil (for example, in the Johnsen arrangements, in the regions where the rows of projections extend between the stator and the motor housing).

### SUMMARY OF THE INVENTION

In its most general sense, the present invention concerns a fluid-cooled electric machine including a rotor disposed on a motor shaft, a stator surrounding the rotor, and a motor housing surrounding the stator, with the stator formed of a laminated stack of stator plates that is plated at its outer surface. With this arrangement, a coolant flow passage is defined between the plated outer surface of the laminated stack of stator plates and the motor housing.

In certain embodiments, the present invention provides an improved electric motor coolant flow channel arrangement which improves cooling performance by greatly increasing the flow path length over which the coolant traverses the stator. In such an arrangement, a stator may be built up by a lamination of plates, which provide for a labyrinthine flowpath at the outer diameter of the stator, requiring the coolant to make a plurality of flow reversals and traverse of essentially the entire width and/or length of the stator between the inlet and outlet of the coolant from the stator.

A stator having a generally cylindrical shape that does not require circumferential projections about its periphery to locate the stator within the motor housing, yet still provides coolant flow channels, may be provided. Such a stator may have stator plates having a generally circular shape and a coolant-traversing notch at one side of the plate, and intermediate circular plates with a reduced diameter. A series of such plates may be alternately laminated together, with a smaller diameter plates between each pair of notched stator plates. Each pair of notched stator plates is assembled with their respective notches being arranged 180° out of phase with one another.

The assembled laminated stator in this embodiment provides a stator with a circular profile and self-contained coolant flow channels. Being circular, this stator may be self-locating within a motor housing having a corresponding inner housing diameter. Further, by incorporating the coolant flow channels within the outer circumferential surface of the stator (the smaller diameter plates creating coolant flow channels between the adjacent notched plates and the inner wall of the motor housing), the present invention avoids any need to enlarge the motor housing to accommodate a cooling channel within the housing itself, desirably minimizing overall electric motor size.

The notches in adjacent pairs of notched stator plates, in this arrangement, are oriented on opposite sides of the stator from one another. This provides a long coolant flow path between the stator inlet notch in the first notched stator plate and the stator outlet notch in the last notched stator plate. Upon entry to the stator at a first stator plate notch, the coolant must flow in the coolant flow channel circumferentially around both sides of the stator to reach the notch in the next of the notched stator plates. Upon passing axially through the second stator plate's notch, the coolant enters the second cooling channel and begin to flow around the stator's circumference to the next notched stator plate's notch. This continuous multiple-pass coolant flow about the full circumference of the stator may continue as many times as there are notched stator plate pairs to form coolant channels, until the coolant reaches the outlet notch in the last notched stator plate and exits the stator's coolant flow path.

This embodiment of the present invention provides stator cooling in a manner which results in uniform cooling across the entire circumference and axial extent of a stator and enhances heat transfer from the stator to the coolant, yet only requires a minimum of different-shaped stator plates (in this embodiment, only two plate shapes, the notched stator plate and a reduced diameter intermediate plate which provides the bottom of the flow channels). This embodiment also provides for simple stator assembly, as only two alternating plate positions must be maintained as the stator laminations are assembled. This is unlike prior art arrangements such as the offset projections of Johnsen, which must be carefully located at each lamination level to ensure the coolant channel integrity is maintained along its stepped axial channels.

In another embodiment, a labyrinthine flow path may be provided by providing a series of stator plates with only one shape, with ribbed end bell sections providing alternating rib closure and bypass sections to form coolant “turn-around” regions in conjunction with the ribs formed by the laminated plates. The combination of these components results in coolant flow channels which require the coolant to traverse the axial length of the stator multiple times while the coolant travels across substantially the entire circumference of the stator.

For example, a first stator plate may be provided with a plurality of small-width tabs extending radially outward from the outer periphery of the plate. End bell sections may be provided with ribs corresponding to the tabs of the first stator plate shape, with every other tab omitted from the periphery of the end bell. A stator in accordance with this embodiment of the present invention may be build-up by assembling a number of plates of the first stator plate shape into a stack having the small-width tabs aligned with one another to form axial walls or rails about the periphery of the partially-assembled stator. At the two axial end faces of the stator, the end bell sections may be added, such that each of the axial walls or rails are closed at one end and open at its other end, thereby forming a serpentine flow channel around the circumference of the stator.

The assembled stator in this embodiment thus may have a coolant flow channel which requires the coolant flowing around the circumference of the stator to repeatedly reverse direction and traverse the axial length of the stator, enhancing the coolant exposure to the stator for enhanced heat transfer along the serpentine coolant flow path. This complex flow path would result from a simple, readily manufactured and cost effective arrangement of a single shape of stator plates.

Regardless of the coolant channel arrangements round the circumference of the stator, the stator coolant inlet and outlet points may be arranged as desired to suit the electric motor design. For example, coolant may be introduced directly into the coolant flow channels from the radial direction via ports in the electric motor housing, or axially into the stator within the motor housing, as long as the inlet and outlet locations are isolated from one another. In some embodiments, the coolant may enter and exit the electric motor via coolant ports provided in the motor housing's end cover regions, such that the coolant circulates within the housing end cover region until it reaches an axial inlet port to the stator, and after leaving the stator may pass through an annular region of the axially-opposite motor end cover to pass out of the motor housing's coolant outlet port.

In order to enhance thermal conductivity between the stator plates and the coolant, as well as to enhance sealing to permit use of water as a coolant, the outside diameter of the laminated stack of stator plates may be plated. This permits the use of water as a coolant, with minimal concerns for electrical grounding issues in the stator.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross-section view of an electric motor according to an embodiment of the present invention.

FIG. 2 is an oblique view of the stator illustrated in cross-section in FIG. 1.

FIG. 3 is a schematic illustration of a side view of a stator in accordance with another embodiment of the present invention showing a serpentine stator coolant flow path arrangement.

### DETAILED DESCRIPTION OF THE INVENTION

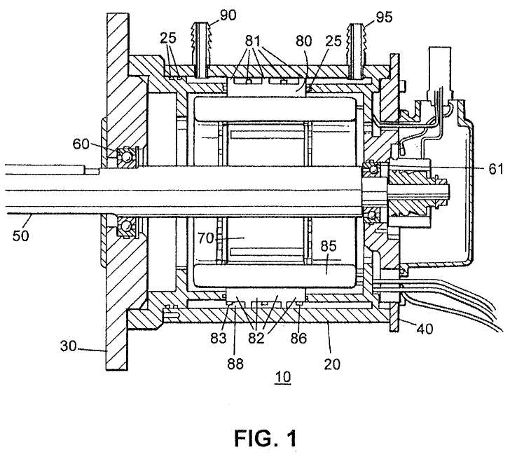

FIG. 1 is across-section view of an electric motor cooled by a coolant medium in accordance with an embodiment of the present invention. The electric motor 10 has a motor housing 20 and housing end covers 30, 40. A motor shaft 50 is rotatably mounted in bearings 60, 61. A motor rotor 70 is located in a non-rotating manner on motor shaft 50, and rotates with the motor shaft 50 concentrically within a stator 80. The stator 80 includes axial slots in which stator windings 85 are located. The stator windings and the windings of the rotor are electrically connected to external power wires in a conventional manner, not discussed further herein. The motor housing includes a coolant inlet port 90 and a coolant outlet port 95, discussed further, below. The electric motor 10 includes several o-rings 25 for sealing the coolant passages in the assembled electric motor against coolant leakage between the motor components.

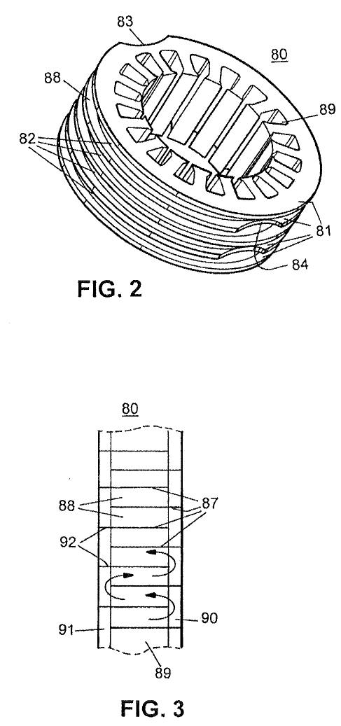

FIG. 2 is an oblique view of the stator 80 illustrated in FIG. 1, shown without the stator windings 85 for clarity of description. The stator is built up from a series of alternating laminated plates 81, 82. The first stator plate in the laminated stator is a notched stator plate having a notch 83 at one side of the stator 80. The next plate 82 is a plate with a smaller diameter than the stator plate 81. The smaller-diameter plate 82 is located between the first stator plate 81 and a second stator plate 81 having its coolant transfer notch 84 located on the opposite side of the stator 80 from the notch 83 of the first stator plate 81, thereby defining a coolant flow channel 88 in the space between adjacent stator plates 81 and the smaller-diameter plate 82. The smaller diameter of plates 82 is preferably not so small that openings are formed between the coolant channels 88 and the winding-holding slots 89 of the stator.

The alternating stator plate arrangements continue through the axial length of the stator 80, with the coolant crossing serially from one coolant flow channel to the next through opposing stator plate notches, for example, after having flowed from the first coolant channel through stator plate notch 83, the coolant flows through the second coolant flow path 88 to stator plate notch 84 at the opposite side of the stator to flow into the third coolant flow passage 88. This pattern continues until the coolant passes through the final coolant channel 88 and leaves the stator through stator plate notch 86 (not shown in FIG. 2; see FIG. 1). Further, the stator plates are plated to provide an improved surface finish to improve sealing between the stator plates. The improved sealing facilitates the use of water as a coolant, in lieu of commonly-used oil coolants.

The coolant which is to pass through the stator cooling channels may reach the stator through any suitable flow path. In the embodiment shown in FIG. 1, the coolant enters the electric motor through coolant inlet port 90 into the annular space between the motor housing 20 and the end cover 60 to reach the stator coolant inlet notch 83. Similarly, the coolant leaving the stator outlet notch 86 enters an annular region, isolated from the inlet annular region, and leaves the electric motor housing 20 through coolant outlet port 95.

In the embodiment of FIGS. 1-2, the labyrinthine coolant flow path is generally oriented circumferentially, with coolant channel cross-over points (notches 83, 84) being provided on opposite sides of the stator so that the coolant flows over the entire circumferential coolant channel before passing axially to the next coolant channel. Alternatively, the stator plates may be arranged with axially-aligned flow channel-defining features which, when combined in a laminated stator, define a series of parallel axially-aligned coolant channel walls having flow cross-over and reversing openings at every other wall end, as shown in FIG. 3.

FIG. 3 shows a partial side view of the stator 80, in which this embodiment's alternative coolant channel wall arrangement causes the coolant to flow around the circumference of the stator 80 following a serpentine flow path having axially-oriented coolant flow channels 88 defined by axial walls 87. The axial walls are built up from the stacking of stator plates 89 having small-width tabs extending radially outward from the plates (shown in FIG. 3 as a single stack of plates for clarity of illustration). At the axial ends of the stator 80, the bell end sections 91 are arranged with every other small-width rib 92 omitted, and are installed in a staggered manner so that one end of each axial wall 87 is closed to coolant flow and the other end is open to permit coolant to pass from one coolant channel 88 to the next channel in a serpentine manner. In addition to reversing the flow between adjacent coolant flow channels, the bell end sections are arranged to also provide cooling capacity which may assist in cooling the stator winding ends which are immediately concentrically-adjacent to the bell ends. As with the embodiment of FIGS. 1-2, alternative coolant inlet and outlet paths may be provided to introduce and extract coolant to/from the first and last coolant channels 88, respectively. For example, coolant may be introduced radially into the first coolant channel directly from a motor housing inlet port aligned with the first coolant channel 88, in lieu of the FIG. 1 embodiment's axial coolant inlet notch 83.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fluid-cooled electric machine comprising:
a rotor disposed on a motor shaft,
a stator surrounding the rotor, and
a motor housing surrounding the stator,
wherein the stator is formed of a laminated stack of stator plates that is plated at its outer surface, and
wherein a coolant flow passage is defined between the plated outer surface of the laminated stack of stator plates and the motor housing.

2. The fluid-cooled electric machine as recited in claim 1, wherein the coolant flow passage is one of a plurality of coolant flow passages arranged on an outer circumference of the stator, the coolant flow passages being arranged to require a coolant flowing there the coolant flow passages to traverse at least one-half of the circumference of the stator and to reverse flow direction at least once between a coolant entry point of the stator and a coolant exit point of the stator.

3. The fluid-cooled electric machine as recited in claim 2, wherein
the stack of stator plates includes at least two stator plates having a feature on an outer circumference thereof which, when assembled into the stator, defines at least a portion of a coolant flow channel.

4. The fluid-cooled electric machine as recited in claim 3, wherein
the outer circumference feature is at least one of a portion of a wall of the coolant flow channel and a portion of a coolant flow crossing point through which coolant passes between adjacent coolant flow channels.

5. The fluid-cooled electric machine as recited in claim 4, wherein
the coolant flow channel wall includes an opening between adjacent coolant flow channels which is located on the outer circumference of the stator such that coolant passing through the opening into a second of the adjacent coolant flow channels reverses flow direction from a flow direction in the first of the adjacent coolant flow channels.

6. The fluid-cooled electric machine as recited in claim 5, wherein
the plurality of coolant flow channels are aligned in a circumferential direction around the outer circumference of the stator.

7. The fluid-cooled electric machine as recited in claim 6, wherein
the opening between adjacent coolant flow channels is arranged such that coolant flowing between adjacent coolant flow channels flows in an axial direction as the coolant passes between the adjacent coolant flow channels.

8. The fluid-cooled electric machine as recited in claim 5, wherein
the plurality of coolant flow channels are aligned in an axial direction around the outer circumference of the stator.

9. The fluid-cooled electric machine as recited in claim 8, wherein
the opening between adjacent coolant flow channels is arranged such that coolant flowing between adjacent coolant flow channels flows in a circumferential direction around the outer circumference of the stator as the coolant passes between the adjacent coolant flow channels.

10. The fluid-cooled electric machine as recited in claim 9, wherein
the opening between adjacent coolant flow channels is located on a stator bell end section arranged on each end of the assembled plurality of stator plates.

11. The fluid-cooled electric machine as recited in claim 1, wherein
the plated outer surface operates to seal the stack of stator plates against coolant migration into interior regions of the stator.

12. A stator that is to form a part of a fluid-cooled electric machine including a rotor surrounded by the stator and disposed on a motor shaft, and a motor housing surrounding the stator, the stator comprising:
a laminated stack of stator plates, and
plating at an outer surface of the laminated stack,
wherein, when the stator is received within the motor housing, a coolant flow passage is defined between the plated outer surface of the laminated stack of stator plates and the motor housing.
